(19) United States
(12) Patent Application Publication
(10) Pub. No.: US 2017/0254346 A1
(43) Pub. Date: Sep. 7, 2017

(54) Threaded post with negative ribs

(71) Applicant: Christopher Adam McLeod, Toronto (CA)

(72) Inventor: Christopher Adam McLeod, Toronto (CA)

(21) Appl. No.: 15/062,170

(22) Filed: Mar. 6, 2016

(51) Int. Cl. F16B 5/02; F16B 35/06

(52) U.S. Cl. CPC F16B 5/02; F16B 35/06

(57) ABSTRACT

A nut and bolt fastens two perforated flat plates by threading fully into a nut on the opposing side of the plates. A threaded post, emanating from a flat, threaded into a complementarily threaded post hole cannot be equipped with strengthening features such as chamfers, fillets, or ribs because these devices block the strengthened threaded post from being fully threaded through perforated plates into a threaded posthole. The negative rib is a concavity spanning the orthogonal join between the post and the flat from which it emanates, and provides the same benefits that a regular rib provides, including discontinuity of join between post and flat, a variable distribution of forces amongst a more complex boundary area between post and flat, and the ability to increase the number, width, and depth of negative rib to achieve design objectives. The negative rib can also be decorated with fillets further strengthening the post against dehiscion from the flat to which it is attached.

### CROSS-REFERENCE TO RELATED APPLICATIONS

No cross reference is made to other applications.

### STATEMENT REGARDING FEDERALLY SPONSORED RESEARCH OF DEVELOPMENT

No Federal Government support was received in the development of this Invention.

### SEQUENCE LISTING, TABLE, OR COMPUTER PROGRAM LISTING

No sequence listing, table, or computer program is attached or accompanies this Application.

### FIELD OF THE INVENTION

The present Invention relates generally to fasteners, and more particularly to threaded posts emanating from a generally planar surface, including but not restricted to bolts. A post is defined as a regular cylindrical prism, solid or hollow. A threaded post is defined as a post with a thread helically decorating the external cylindrical surface of the post. A bolt is defined as an externally threaded post emanating from a generally planar surface constituting the underside of a polygonal prismatic structure equipped with lateral flats for the application of torque, such as supplied by the application of a wrench. A bolt head is defined as said prismatic structure. A posthole is a cavity or perforation in a second part. Said posthole is equipped with an internal thread with engineering characteristics including thread count, pitch shape, length, and diameter. A thread mate can be achieved between the externally threaded post of a bolt and an internally threaded posthole in a second part, if said engineering characteristics are designed to be complementary or matching. A bolt threaded into a matching internally threaded post hole set into or perforating a second part constitutes a thread mate. Threading in the bolt fully is achieved by means of application of torque to flat features provided on laterally on the bolt head. A bolt is threaded between a plurality of perforated flat surfaces prior to threading into a nut or other posthole structure. Once the bolt is fully threaded into adjacent to the underside of the posthole, the flat on the underside of the bolt head coincides with the closest generally flat surface. Torque on the bolt head forces the flats together to achieve a stressed flat mate. The thread mate at this point is also torqued into a stressed position. Overtorquing is defined as the application of torque that exceeds a breaking point in the bolt or nut in a thread mate.

### BACKGROUND OF THE INVENTION

The thread mate between a bolt and a nut is an ancient device for fastening, by the clamping of a plurality of thin, perforated, generally planar surfaces between the underside of the bolt head and the nut flat surface. Torque on a bolt head forces the flats together to achieve a stressed flat mate that works in concert with the stressed thread mate to prevent unthreading of the thread mate, a critical engineering objective.

Provision of excess torque force on the bolt head can overcome the attachment of the bolt head to the externally threaded post, failure occurring at the orthogonal discontinuity constituted by the circular join occurring between the thread post and the bolt head. The necessity of complete threading in to achieve said stressed mates prevents the use of conventional join strengthening devices such as ribs and fillets, leading to the dehiscion of the bolt head from the threaded bolt body, solid or hollow, upon overtorquing of the bolt head.

In contrast, the Invention presented in this Application allows complete threading in of a threaded post while providing protection against dehiscion of the threaded post from the generally planar surface of a part, through the decoration of said threaded post and generally planar surface with negative ribs, optionally provided with fillets on discontinuous edges.

### SUMMARY OF THE INVENTION

This Application describes the device constituting the negative rib. The negative rib refers to a cavity that spans the join between a threaded post, as in but not restricted to a bolt threaded post, and the generally flat surface of a head structure from which said threaded post emanates, as in but not restricted to a bolt head. Said cavity does not perforate either the post surface nor the generally flat plane to which the post is attached. The negative rib interrupts the circular join between the threaded post and the generally flat surface of the head and in so doing provides support against dehiscion of the post upon application of torque to the head after complete threading in of the threaded post into a complementarily threaded posthole in a second part. The negative rib thereby enables complete threading in of the threaded post into the threaded posthole. Strengthening of said negative rib can be achieved by variation in number, width, and depth of the negative rib as well as by filleting of sharp edges in the negative rib.

### BRIEF DESCRIPTION OF THE DRAWINGS

FIG. 1 illustrates an isometric view of an externally threaded post emanating from the underside of a bolt head.

### DETAILED DESCRIPTION OF THE INVENTION

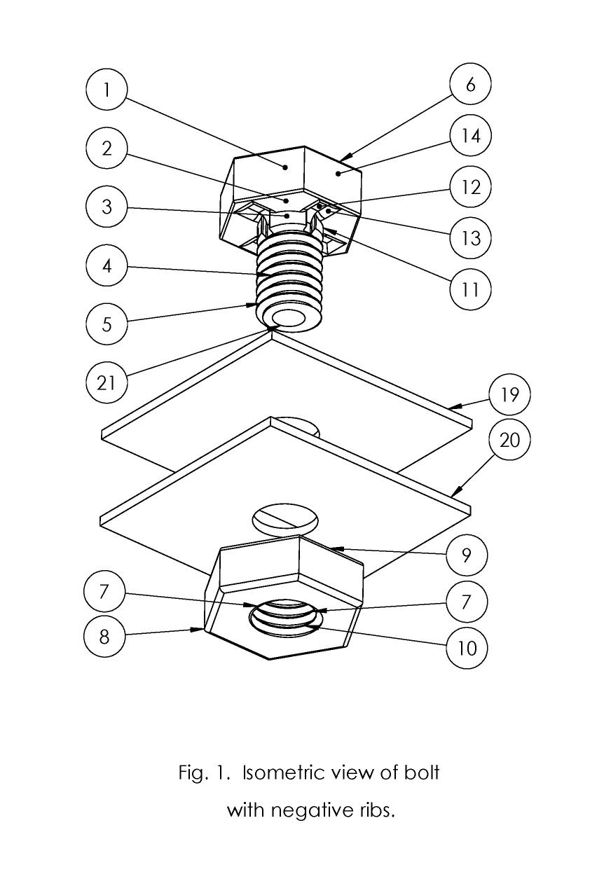

The bolt shown in FIG. 1 shows a flat surface 2 from which a threaded post 4 emanates. Said flat 2 corresponds to, but is not restricted to, the underside of a bolt head 6. The threaded post 4 bears an external thread 5 decorating its cylindrical surface 3. The external thread 5 runs helically from the post terminus 21 up to the flat 1 in order that the bolt may be fully threaded into a complementary posthole 7 in another part 8 until the flat 2 coincides with a flat structure 19 in between the bolt head 6 and a generally planar flat surface 9 of the second part 8, including, but not restricted to, a nut. A threadmate can be established between the external thread 5 of the threaded post 4 and the complementary internal thread 10 of the posthole 7. Application of torque on the lateral flats 14 of the bolt head 6 will establish a tension lock between said threadmate and all adjacent generally planar flat surfaces of parts 19, 20 and 8. This is the mechanical meaning of “tightening” two perforated flat structures together with a bolt and nut. Application of sufficient torque to the bolt head 6 will tighten the bolt 1 sufficiently to resist unthreading of the bolt. If the torque applied to tighten the bolt 1 exceeds the breaking point of the bolt 1, dehiscion of the threaded post 4 occurs at the join 11 between the threaded post 4 and the generally flat surface 2 from which said post emanates.

Addition of ribs or robust fillets or chamfers spanning the join 11 between the threaded post 4 and the generally planar flat surface 2 from which the threaded post 4 emanates could improve the breaking point characteristics of the bolt 1 at the join 11. However, the addition of structures at the join would block full tightening of the bolt 1 to the second part 8 through the perforated planar structures 19 and 20

FIG. 1 shows the addition of a plurality of negative ribs 12 to the bolt 1 that span the join 11 from the threaded post 4 to the generally planar flat 2 of the underside of the bolt. A negative rib 12 are composed of a concave depression in the body of the thread post 4 that is contiguous with a concave depression in the generally planar flat surface 2 to which said threaded post 3 is attached. A plurality of negative ribs establishes resistance to dehiscion of the threaded post 4 from the planar flat. Similar to ribs, a rectangularly shaped depression with the long central axis of the rectangular depression on the threaded post being contiguous, and equal in width of depth provide for optimum resistance to torque. Further, fillets 13 on the edge of said negative rib 12 provide further resistance to torque. Negative ribs thereby allow for the provision of torque resistance both through the provision of a join interruption effect and through the curving of sharp edges.

FIG. 1 also shows that the negative ribs 12 interrupt the external thread 5 on the threaded post 4. Said interruption by a plurality of ribs are sized to not interfere with the threadmate functionality of the threaded post 4 into a complementarily threaded posthole 6.

The following claims are made about the invention described in this application:

1. A cylindrical post emanating from a larger flat surface, wherein:
a plurality of cavities are distributed in a circular pattern about the cylindrical axis of the post, each cavity spanning the join of the post to the larger flat surface but not perforating either surface into which it is formed.

2. A post as claimed in claim 1, wherein:
the post is externally threaded, excepting the spaces comprised by said plurality of cavities, thus forming a discontinuous yet functional thread.

3. A threaded post as in claim 2, wherein:
edges of said plurality of cavities are filleted to provide further strengthening against dehiscion of the post.
